(19) United States
(12) Patent Application Publication
(10) Pub. No.: US 2015/0082134 A1
(43) Pub. Date: Mar. 19, 2015

(54) SIGNAGE DATA INPUT DEVICE, SERVER, AND SIGNAGE DATA INPUT METHOD

(71) Applicant: PANASONIC CORPORATION, Osaka (JP)

(72) Inventors: Koichiro YAMAGUCHI, Osaka (JP); Hiroki SHINOHARA, Kyoto (JP)

(21) Appl. No.: 14/460,125

(22) Filed: Aug. 14, 2014

(30) Foreign Application Priority Data
Sep. 18, 2013 (JP) 2013-192511
Jul. 14, 2014 (JP) 2014-143814

(51) Int. Cl. G06F 17/24

(52) U.S. Cl. CPC G06F 17/24
USPC 715/202

(57) ABSTRACT

A signage data input device of the present disclosure is a signage data input device which performs editing in conjunction with signage data displayed on a signage display device, the signage data input device including an item receiving unit configured to receive an editable item in conjunction with the signage data displayed on the signage display device, an editing unit configured to display an edit screen for editing the editable item and accepting edit-content information, and a change transmitting unit configured to transmit the edit-content information as an edit instruction.

### BACKGROUND OF THE INVENTION

1. Field of the Invention

The present disclosure relates to a signage data input device, a server, and a signage input method.

2. Description of the Related Art

In recent years, digital signage (hereinafter, referred to as signage) is becoming widespread with lowering in the price of a display device. One of the advantages of the signage is that display-content information can be easily changed.

PTL 1 discloses a signage system in which content information of the signage can be changed using a portable telephone and a personal computer. According to such a technique, an on-site operator can easily change the display-content information.

### CITATION LIST

### Patent Literature

PTL 1: Unexamined Japanese Patent Publication No. 2009-175873

### SUMMARY OF THE INVENTION

However, PTL 1 merely describes the using terminal in changing the content information of the signage, and does not disclose details of the changing method. The present disclosure discloses a data input device that simply changes the display-content information while checking the content information in which the signage is displayed.

A signage data input device of the present disclosure is a signage data input device which performs editing in conjunction with signage data displayed on a signage display device, and includes an item receiving unit configured to receive an editable item in conjunction with the signage data displayed on the signage display device, an editing unit configured to display an edit screen for editing the editable item and accepts edit-content information, and a change transmitting unit configured to transmit the edit-content information as an edit instruction.

Thus, the display-content information can be easily changed in conjunction with the display-content information of the signage display device.

The data input device according to the present disclosure can easily change the display-content information of the signage.

### BRIEF DESCRIPTION OF DRAWINGS

FIG. 1 is a diagram showing a configuration of data input system;

FIG. 2 is a view showing one example in which a signage display device displays signage data;

FIG. 3A is a view showing one example of a format of the signage data;

FIG. 3B is a view showing one example of the signage data defined with the format of the signage data of FIG. 3A;

FIG. 4 is a view showing one example of a display of an edit screen of a signage data input device;

FIG. 5 is a view showing one example in which editing is carried out using the edit screen of the signage data input device;

FIG. 6 is a function block diagram of a signage server;

FIG. 7 is a flowchart showing an operation of transmission and reception of a log of the signage server;

FIG. 8A is a view showing a format of a playback log;

FIG. 8B is a view showing a format of an update log;

FIG. 8C is a view showing a playback log with respect to the display of DS 201 defined with the format of the playback log of FIG. 8A;

FIG. 8D is a view showing a playback log with respect to the display of DS 202 defined with the format of the playback log of FIG. 8A;

FIG. 8E is a view showing a playback log with respect to the display of DS 203 defined with the format of the playback log of FIG. 8A;

FIG. 8F is a view showing a playback log with respect to the display of DS 204 defined with the format of the playback log of FIG. 8A;

FIG. 8G is a view showing an update log with respect to the display of DS 203A defined with the format of the update log of FIG. 8B;

FIG. 9A is a view showing a format of an editable item;

FIG. 9B is a view showing an editable item with respect to the display of DS 201 defined with the format of FIG. 9A;

FIG. 9C is a view showing an editable item with respect to the display of DS 202 defined with the format of FIG. 9A;

FIG. 9D is a view showing an editable item with respect to the display of DS 203 defined with the format of FIG. 9A;

FIG. 9E is a view showing an editable item with respect to the display of DS 204 defined with the format of FIG. 9A;

FIG. 9F is a view showing a format of update-content information;

FIG. 9G is a view showing update-content information with respect to the display of DS 203A defined with the format of FIG. 9F;

FIG. 10 is a flowchart showing an operation of an edit instruction of the signage server;

FIG. 11A is a view showing a format of the edit instruction;

FIG. 11B is a view showing the edit instruction corresponding to an edit screen of ED 203A defined with the format of FIG. 11A;

FIG. 12 is a function block diagram of the signage data input device;

FIG. 13 is a flowchart showing an operation of the signage data input device;

FIG. 14 is a function block diagram of the signage display device;

FIG. 15 is a flowchart showing an operation of the signage display device;

FIG. 16 is a view showing another example in which editing is performed using the edit screen of the signage data input device;

FIG. 17 is a view showing still another example in which editing is performed using the edit screen of the signage data input device;

FIG. 18 is a view showing another example in which the signage display device displays the signage data;

FIG. 19 is a view showing another example in which a plurality of editable items are present in the edit screen of the signage data input device;

FIG. 20A is a view showing another example of the signage data defined with the format of the signage data of FIG. 3A;

FIG. 20B is a view showing a playback log with respect to DS 1801 defined with the format of the playback log of FIG. 8A;

FIG. 20C is a view showing an editable item with respect to the display of DS 1801 defined with the format of FIG. 9A;

FIG. 20D is a view showing an edit instruction corresponding to the edit screen of ED 1801B defined with the format of FIG. 11A;

FIG. 20E is a view showing an update log with respect to the display of DS 1801A defined with the format of the update log of FIG. 8B; and

FIG. 20F is a view showing update-content information with respect to the display of DS 1801A defined with the format of FIG. 9F.

### DETAILED DESCRIPTION OF THE PREFERRED EMBODIMENT

Hereinafter, exemplary embodiments will be described in detail with reference to the drawings as appropriate. Description in more detail than necessary may be omitted. For example, the detailed description of the already well-known matter and the redundant description on substantially the same configuration may be omitted. This is to prevent the following description from becoming unnecessarily redundant and to facilitate the understanding of those skilled in the art.

The inventors provide the accompanying drawings and the following description to enable those skilled in the art to fully understand the present disclosure, and do not intend to limit the subject matter described in the claims with the drawings and the description.

Hereinafter, the exemplary embodiments of the present disclosure will be described with reference to the drawings.

### Exemplary Embodiment

A data input system of the present disclosure will be described below.

### [1-1. Configuration of Data Input System]

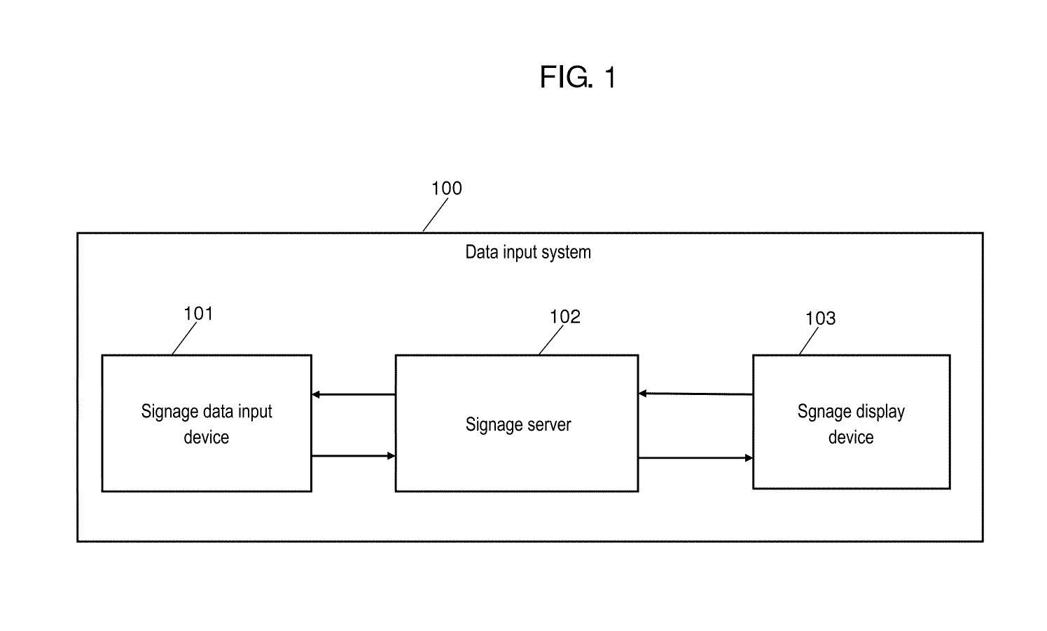

FIG. 1 is a diagram showing a configuration of data input system 100. Data input system 100 is configured by signage data input device 101, signage server 102, and signage display device 103.

The communication of signage server 102 and signage display device 103 is established by transmitting a display device ID, which is information with which signage display device 103 can be identified. Furthermore, a secure communication method may be adopted in the communication to prevent impersonation and the like.

Signage server 102 sends signage data to be displayed to signage display device 103. Signage display device 103 displays the received signage data. Signage display device 103 transmits a playback log, which indicates the displayed content information, to signage server 102 in correspondence with the display of the signage data. In this case, the display device ID, which is the information with which the signage display device can be identified, may be transmitted with the playback log.

Signage server 102 receives the playback log from signage display device 103, and transmits an editable item in conjunction with the displayed signage data to signage data input device 101 based on the playback log. The communication of signage server 102 and signage data input device 101 is established by transmitting a terminal ID, which enables signage data input device 101 to be identifiable. Furthermore, a secure communication method may be adopted in the communication to prevent impersonation and the like.

Signage data input device 101 receives the editable item from signage server 102. The editable item is displayed so that the content information displayed on signage display device 103 can be edited according to the received editable item. When editing is carried out on the displayed item, the edited content information is transmitted to signage server 102.

Upon receipt of the edited content information from signage data input device 101, signage server 102 transmits the received edited content information to signage display device 103.

Signage display device 103 updates the display-content information according to the received edited signage data. In this case, the update log indicating that update has been carried out is transmitted to signage server 102.

### [1-2. Display and Editing of Signage Data]

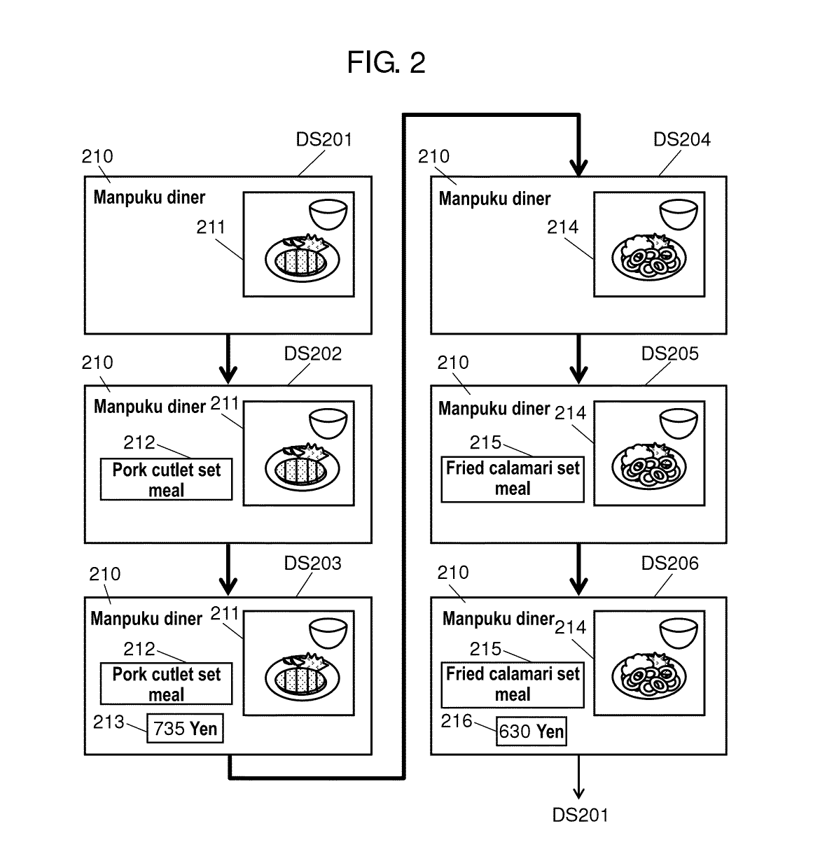

FIG. 2 is a view showing one example in which signage display device 103 displays the signage data received from signage server 102. Specifically, FIG. 2 shows one example in which the content indicating a menu of “Manpuku Diner”, which is a restaurant, is displayed as the signage data. The contents are displayed in the order of DS 201, DS 202, DS 203, DS 204, DS 205, and DS 206. DS 201, DS 202, and DS 203 are displays for “Pork Cutlet Set Meal”, which is one of the menus. In DS 201, restaurant name 210 of “Manpuku Diner”, which indicates the name of the restaurant, and picture 211 of “Pork Cutlet Set Meal” are displayed for three seconds, for example. In DS 202, menu name 212 of “Pork Cutlet Set Meal” is added to the display of DS 201, and displayed for three seconds, for example. In DS 203, price 213 of “735 yen”, which indicates a price, is added to the display of DS 202, and displayed for three seconds, for example. The subsequent DS 204, DS 205, and DS 206 are displays for “Fried Calamari Set Meal”, which is one of the menus. DS 203, which is the display of “Pork Cutlet Set Meal”, is switched to the display of “Fried Calamari Set Meal”. In DS 204, restaurant name 210 of “Manpuku Diner”, which indicates the name of the restaurant, and picture 214 of “Fried Calamari Set Meal” are displayed for three seconds, for example. In DS 205, menu name 215 of “Fried Calamari Set Meal” is added to the display of DS 204, and displayed for three seconds, for example. In DS 206, price 216 of “630 yen”, which indicates the price, is added to the display of DS 205, and displayed for three seconds, for example. Thereafter, DS 206, which is the display of “Fried Calamari Set Meal”, is returned to the display of “Pork Cutlet Set Meal”. One menu is thus configured such that the picture, the menu name, and the price are each independently editable.

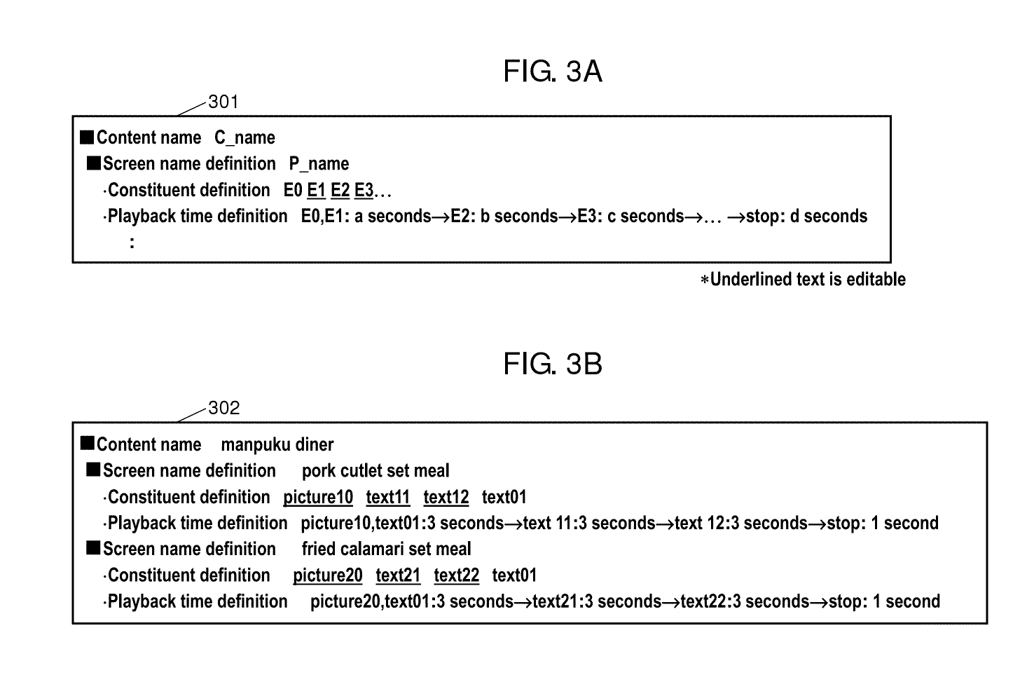

FIG. 3A is a view showing one example of signage data format 301, and FIG. 3B is a view showing one example of signage data 302 in which the signage data described in FIG. 2 is defined with signage data format 301 of FIG. 3A.

In signage data format 301, the description of “content name” that identifies the content of the signage is made first. Signage data format 301 is then configured by “screen name definition” that configures the content, “constituent definition” that configures the screen, and “playback time definition”. The “constituent definition” defines the constituents configuring one screen. A plurality of constituents can be defined. The editable constituent can be identified by underlining. The “playback time definition” defines the playback order and the playback time of each constituent using the constituents defined in the “constituent definition”.

The constituent defined in the “constituent definition” and not defined in the “playback time definition” may be always displayed during the playback of the screen.

The “playback time definition” may define not only the playback order and the playback time of each constituent, but also wipe, scroll, and the like as a playback effect, for example, an effect of screen switching.

In signage data 302 of FIG. 3B, the content with the content name “Manpuku Diner” is defined. “Pork Cutlet Set Meal” and “Fried Calamari Set Meal” are defined as the screen names. In the definition of the screen name “Pork Cutlet Set Meal”, “picture 10”, “text 11”, “text 12”, and “text 01” are defined as the constituent definitions, and “picture 10”, “text 11”, and “text 12” are underlined so that such constituents are editably defined. “Picture 10” corresponds to picture 211 of “Pork Cutlet Set Meal” in FIG. 2, “text 11” corresponds to menu name 212 of “Pork Cutlet Set Meal” in FIG. 2, “text 12” corresponds to price 213 of “735 yen” in FIG. 2, and “text 01” corresponds to restaurant name 210 of “Manpuku Diner” in FIG. 2. In the definition of the screen name “Pork Cutlet Set Meal”, definition is made, as the playback time definition, to display “picture 10” and “text 01” for three seconds, add “text 11” and display for three seconds, add “text 12” and display for three seconds, and terminate the playback after one second. The display of DS 201, DS 202, and DS 203 in FIG. 2 is carried out according to such definitions.

In the definition of the screen name “Fried Calamari Set Meal”, “picture 20”, “text 21”, “text 22”, and “text 01” are defined as the constituent definitions, and “picture 20”, “text 21”, and “text 22” are underlined so that such constituents are editably defined. Here, “picture 20” corresponds to picture 214 of “Fried Calamari Set Meal” in FIG. 2, “text 21” corresponds to menu name 215 of “Fried Calamari Set Meal” in FIG. 2, “text 22” corresponds to price 216 of “630 yen” in FIG. 2, and “text 01” corresponds to restaurant name 210 of “Manpuku Diner” in FIG. 2. In the definition in which the screen name is “Fried Calamari Set Meal”, definition is made, as the playback time definition, to display “picture 20” and “text 01” for three seconds, add “text 21” and display for three seconds, add “text 22” and display for three seconds, and terminate the playback after one second. The display of DS 204, DS 205, and DS 206 in FIG. 2 is carried out according to such definitions.

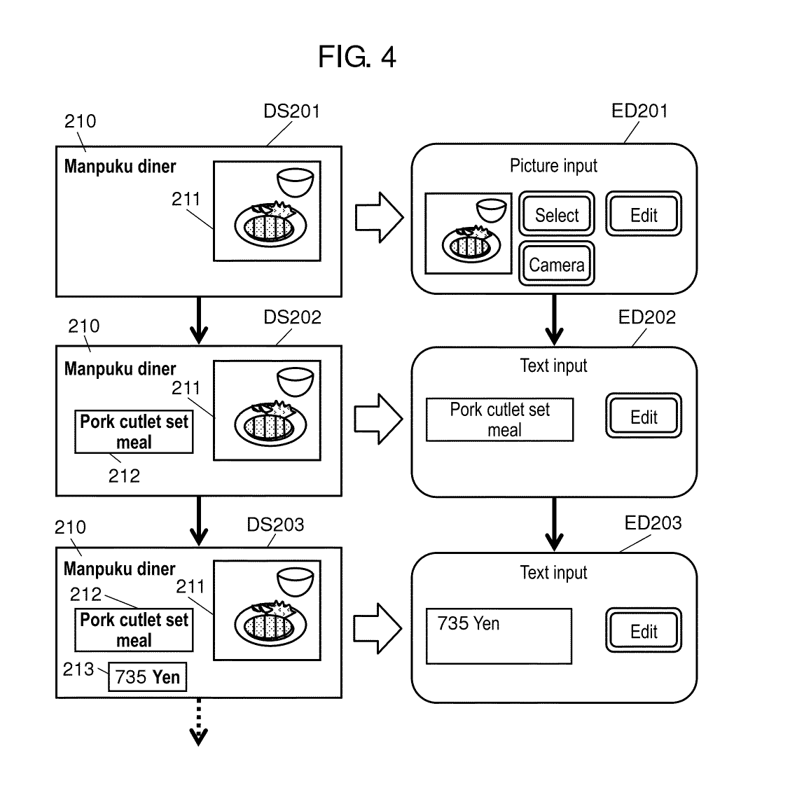

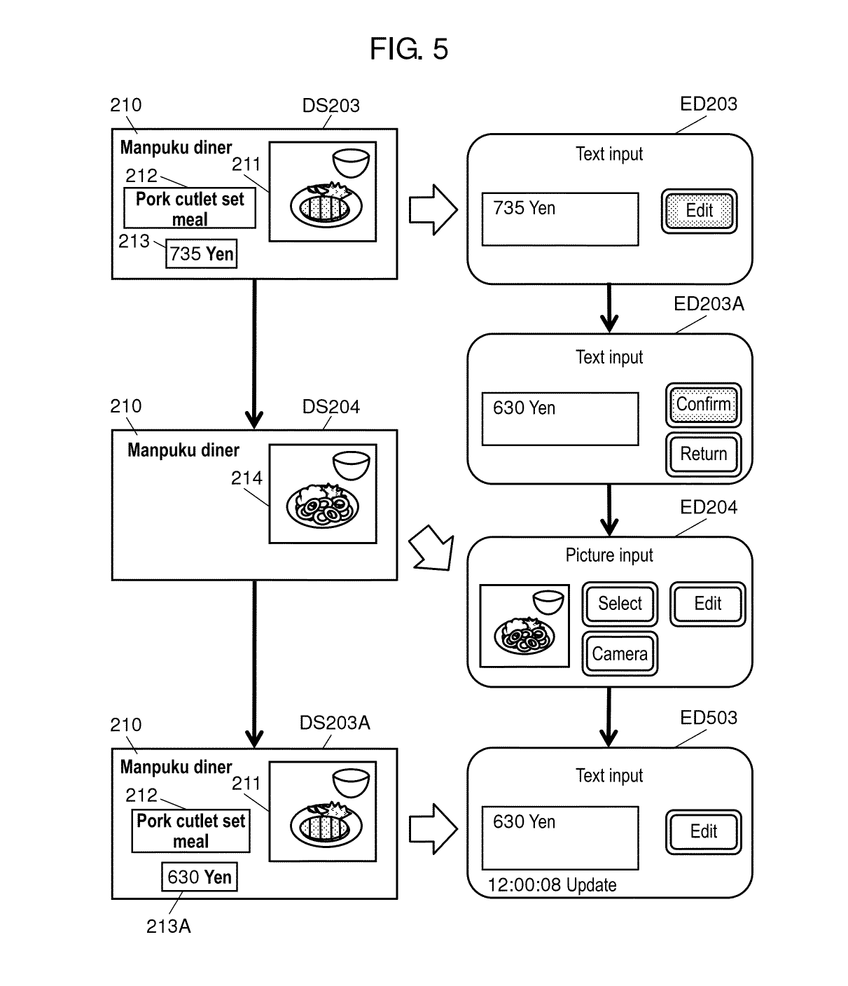

FIG. 4 is a view showing one example of a display of an edit screen of signage data input device 101 in correspondence with signage data 302 displayed by signage display device 103 of FIG. 2, and FIG. 5 is a view showing one example in which editing is carried out after displaying an edit screen on signage data input device 101 in correspondence with signage data 302 displayed by signage display device 103 of FIG. 2.

In FIG. 4, the left side of the figure is a part of signage data 302 displayed by signage display device 103 of FIG. 2, and shows DS 201, DS 202, DS 203, which are contents of “Pork Cutlet Set Meal”, one of the menus of “Manpuku Diner”. The right side of the figure is the edit screen of signage data input device 101. When DS 201 is displayed on signage display device 103, the displayed content information is transmitted from signage display device 103 to signage server 102 as a playback log. Signage server 102 that received the playback log transmits picture 211 of “Pork Cutlet Set Meal”, which is an editable item of DS 201, to signage data input device 101. Signage data input device 101 displays ED 201, which is an edit screen for editing picture 211 of “Pork Cutlet Set Meal”. ED 201 is provided for editing the picture, and includes an “edit” button for starting the editing, a “select” button for using the pictures accumulated in signage data input device 101, and a “camera” button for using the pictures photographed by a camera provided in signage data input device 101.

Configuration may be such that correction of the picture and writing of the handwritten characters, illustrations, and the like to the picture can be carried out.

Then, when DS 202 is displayed on signage display device 103, the displayed content information is transmitted from signage display device 103 to signage server 102 as a playback log. Signage server 102 that received the playback log transmits menu name 212 of “Pork Cutlet Set Meal”, which is an editable item of DS 202, to signage data input device 101. Signage data input device 101 displays ED 202, which is an edit screen for editing menu name 212 of “Pork Cutlet Set Meal”. ED 202 is provided for editing the text, and includes a region for inputting the text and also includes an “edit” button for starting the editing. “Pork Cutlet Set Meal”, which is the current text, is displayed in the region for inputting the text. The current text can be partially corrected.

When DS 203 is displayed on signage display device 103, the displayed content information is transmitted from signage display device 103 to signage server 102 as a playback log. Signage server 102 that received the playback log transmits price 213 of “735 yen”, which is an editable item of DS 203, to signage data input device 101. Signage data input device 101 displays ED 203, which is an edit screen for editing price 213 of “735 yen”. ED 203 is provided for editing the text, and includes a region for inputting the text and also includes an “edit” button for starting the editing.

In FIG. 5, the left side of the figure is a part of signage data 302 displayed by signage display device 103 of FIG. 2. The right side of the figure is the edit screen of signage data input device 101. When DS 203 is displayed on signage display device 103, the displayed content information is transmitted from signage display device 103 to signage server 102 as a playback log. Signage server 102 that received the playback log transmits price 213 of “735 yen”, which is an editable item of DS 203, to signage data input device 101. Signage data input device 101 displays ED 203, which is the edit screen for editing price 213 of “735 yen”. ED 203 is provided for editing the text, and includes a region for inputting the text and also includes an “edit” button for starting the editing.

The user presses the “edit” button of ED 203 to update price 213 of “735 yen”. When the “edit” button is pressed, the display screen is switched to ED 203A. The difference with ED 203 is that the “edit” button is changed to a “confirm” button and a “return” button. The editing of the text is carried out in the region for inputting the text, and the “confirm” button is pressed to confirm editing, and the “return” button is pressed to cancel editing. In ED 203A, “735 yen” is edited to “630 yen”. When the “edit” button is pressed in ED 203, notification that the “edit” button is pressed is made from signage data input device 101 to signage server 102, and signage server 102 stops the transmission of the editable item to signage data input device 101 until notification is made that the “confirm” button or “return” button is pressed in ED 203A.

The display of signage display device 103 is continued even while the edit screen of ED 203A is being displayed. When the “confirm” button is pressed in ED 203A, DS 204 is assumed to be displayed on signage display device 103. Signage server 102 then resumes the transmission of the editable item to signage data input device 101, and thus signage data input device 101 displays ED 204.

In signage data input device 101, during the editing of the edit screen, notification may be made that editing is being carried out to signage display device 103, and the display of the signage in signage display device 103 may be stopped. In this case, notification that editing is being carried out may be made from signage server 102 to signage display device 103.

When the “confirm” button is pressed in ED 203A, signage data input device 101 transmits the edited content information to signage server 102, and signage server 102 notifies the edited content information to signage display device 103. Signage display device 103 that received the notification displays DS 203A, which is an update screen of DS 203. Price 213 of “735 yen” is updated to price 213A of “630 yen”. Signage display device 103 transmits an update log indicating that update has been carried out to signage server 102, and signage server 102 transmits the update-content information and the update time to signage data input device 101. Signage data input device 101 displays ED 503, which is an edit screen presenting the update-content information and the update time.

### [1-3. Configuration of Signage Server]

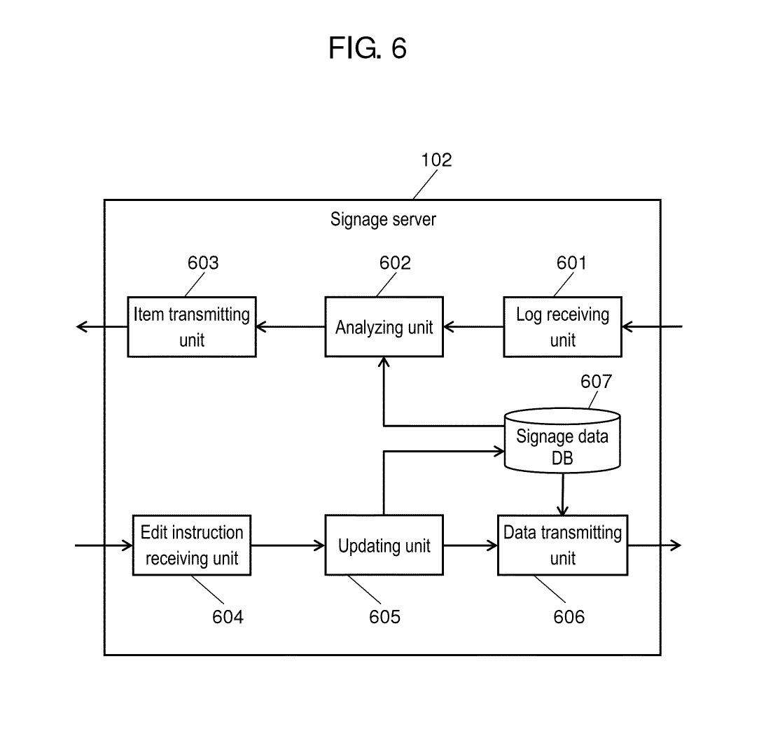

The configuration of signage server 102 will be described below. FIG. 6 is a function block diagram of signage server 102. Signage server 102 is configured by log receiving unit 601, analyzing unit 602, item transmitting unit 603, edit instruction receiving unit 604, updating unit 605, data transmitting unit 606, and signage data DB 607.

Log receiving unit 601, item transmitting unit 603, edit instruction receiving unit 604, and data transmitting unit 606 are realized, for example, by a wireless or wired communication device, and a processor that executes a predetermined process. Analyzing unit 602 and updating unit 605 are realized by a processor that executes a predetermined process. Such functions may be realized by one processor, or may be assigned and realized by a plurality of processors. Signage data DB 607 is realized, for example, by an optically-readable or magnetically-readable recording medium.

Upon receiving the instruction to start the display of the signage data, data transmitting unit 606 extracts corresponding signage data 302 from signage data DB 607, and transmits signage data 302 to signage display device 103.

Signage data 302 may be held in advance by signage display device 103, and may not be transmitted at the same time as the instruction to start the display.

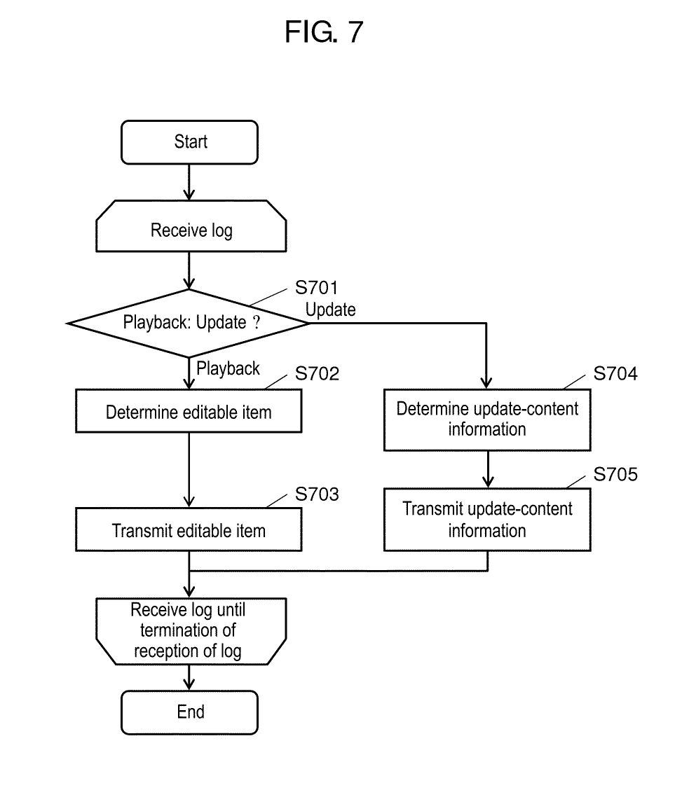

FIG. 7 is a flowchart showing the operation of transmission and reception of the log of signage server 102.

Log receiving unit 601 receives the playback log or the update log transmitted from signage display device 103, and transmits the same to analyzing unit 602. The operation described in FIG. 7 is continued during receipt of the playback log or the update log transmitted from signage display device 103.

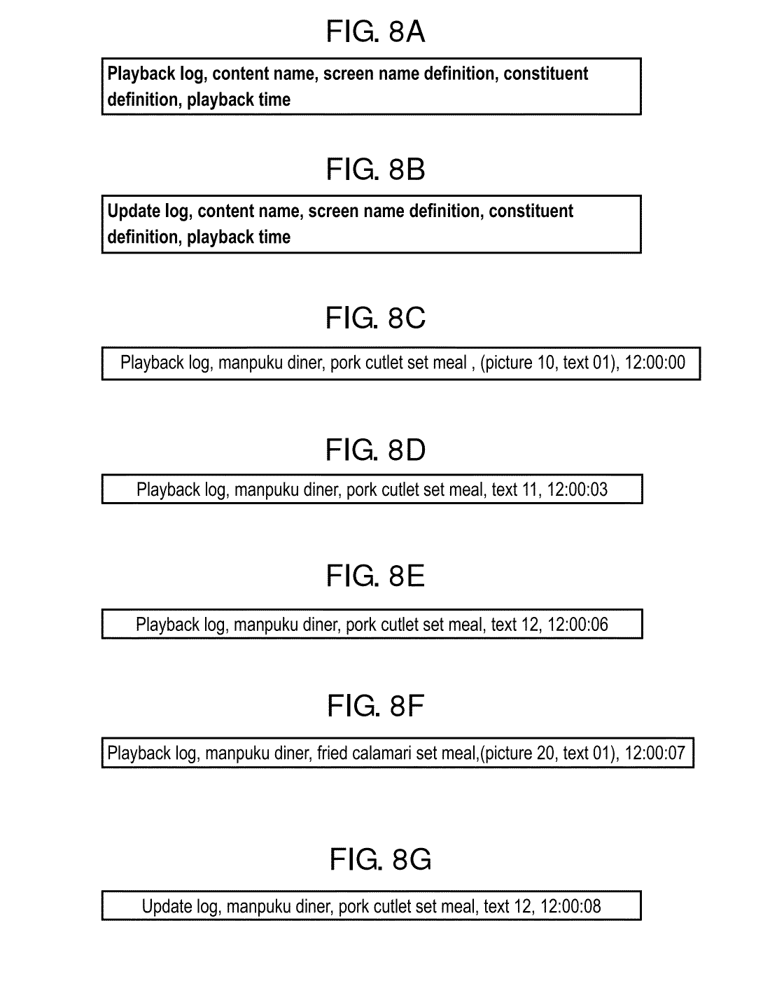

FIG. 8A is a view showing a format of the playback log, FIG. 8B is a view showing a format of the update log, FIG. 8C is a view showing the playback log with respect to the display of DS 201 defined with the format of FIG. 8A, FIG. 8D is a view showing the playback log with respect to the display of DS 202 defined with the format of FIG. 8A, FIG. 8E is a view showing the playback log with respect to the display of DS 203 defined with the format of FIG. 8A, FIG. 8F is a view showing the playback log with respect to the display of DS 204 defined with the format of FIG. 8A, and FIG. 8G is a view showing the update log with respect to the display of DS 203A defined with the format of FIG. 8B.

The format of the playback log of FIG. 8A is defined by the description “playback log”, which represents the playback log, and the “content name”, the “screen name definition”, the “constituent definition”, and the “playback time” of displayed signage data 302. The format of the update log of FIG. 8B is defined by the description “update log”, which represents the update log, and the “content name”, the “screen name definition”, the “constituent definition”, and the “update time” of updated and displayed signage data 302. A plurality of descriptions can be made in the “constituent definition”. Here, each of the “content name”, the “screen name definition”, and the “constituent definition” corresponds to the “content name”, the “screen name definition”, and the “constituent definition” of signage data format 301.

The playback log of FIG. 8C is the playback log with respect to the display of DS 201, and “Manpuku Diner”, “Pork Cutlet Set Meal”, “(picture 10, text 01)”, and “12:00:00” are described after the description of “playback log”. The playback log of FIG. 8D is the playback log with respect to the display of DS 202, and “Manpuku Diner”, “Pork Cutlet Set Meal”, “text 11”, and “12:00:03” are described after the description of “playback log”. The playback log of FIG. 8E is the playback log with respect to the display of DS 203, and “Manpuku Diner”, “Pork Cutlet Set Meal”, “text 12”, and “12:00:06” are described after the description of “playback log”. The playback log of FIG. 8F is the playback log with respect to the display of DS 204, and “Manpuku Diner”, “Fried Calamari Set Meal”, “(picture 20, text 01)”, and “12:00:07” are described after the description of “playback log”. The update log of FIG. 8G is the update log with respect to the display of DS 203A, and “Manpuku Diner”, “Pork Cutlet Set Meal”, “text 12”, and “12:00:08” are described after the description of “update log”.

(S701) Analyzing unit 602 determines whether the received log is the playback log or the update log. When the received log is the playback log (in the case of “playback”), the process proceeds to S702. When the received log is the update log (in the case of “update”), the process proceeds to S704.

(S702) Analyzing unit 602 determines the editable item from the “content name”, the “screen name definition”, and the “constituent definition” included in the playback log, and corresponding signage data 302 stored in signage data DB 607. For example, when the playback log is the case of FIG. 8C, “picture 10” is the editable item compared with signage data 302. When the playback log is the case of FIG. 8D, “text 11” is the editable item, when the playback log is the case of FIG. 8E, “text 12” is the editable item, and when the playback log is the case of FIG. 8F, “picture 20” is the editable item.

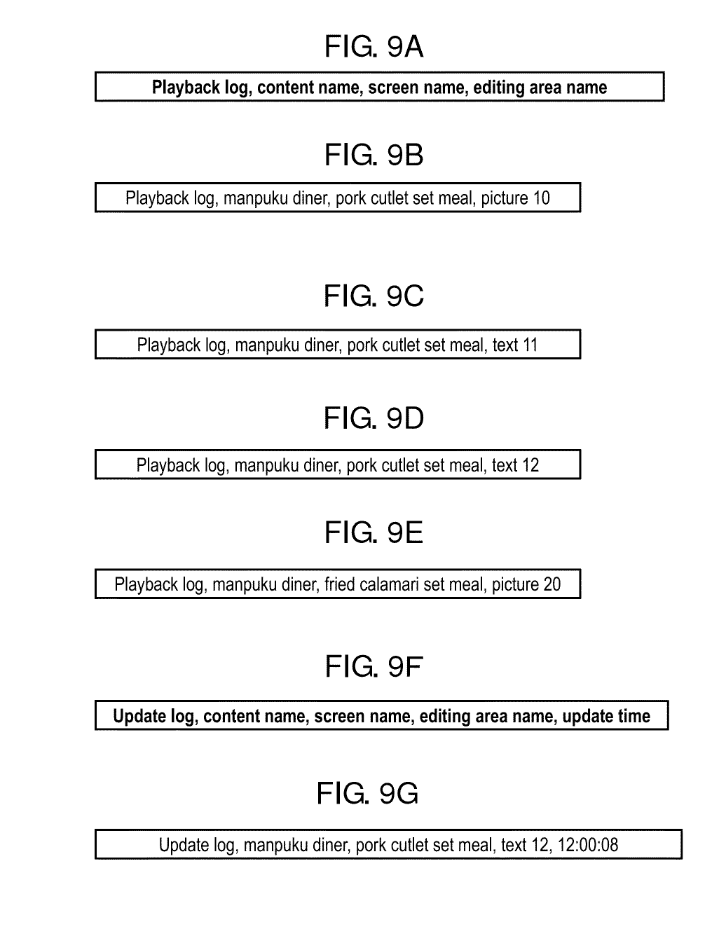

FIG. 9A is a view showing a format of the editable item, FIG. 9B is a view showing the editable item with respect to the display of DS 201 defined with the format of FIG. 9A, FIG. 9C is a view showing the editable item with respect to the display of DS 202 defined with the format of FIG. 9A, FIG. 9D is a view showing the editable item with respect to the display of DS 203 defined with the format of FIG. 9A, and FIG. 9E is a view showing the editable item with respect to the display of DS 204 defined with the format of FIG. 9A. The format of the editable item of FIG. 9A is defined by the description “playback log”, which indicates that the playback log is received and the editable item is determined, and the “content name”, the “screen name”, and the “editing area name” indicating the editable items. A plurality of descriptions can be made in the “editing area name”. Here, each of the “content name”, the “screen name”, and the “editing area name” corresponds to the “content name”, the “screen name definition”, and the “constituent definition” of signage data format 301. The editable item of FIG. 9B is the editable item with respect to the display of DS 201, and “Manpuku Diner”, “Pork Cutlet Set Meal”, and “picture 10” are described after the description of the “playback log”. The editable item of FIG. 9C is the editable item with respect to the display of DS 202, and “Manpuku Diner”, “Pork Cutlet Set Meal”, and “text 11” are described after the description of the “playback log”. The editable item of FIG. 9D is the editable item with respect to the display of DS 203, and “Manpuku Diner”, “Pork Cutlet Set Meal”, “text 12”, and “12:00:06” are described after the description of the “playback log”. The editable item of FIG. 9E is the editable item with respect to the display of DS 204, and “Manpuku Diner”, “Fried Calamari Set Meal”, and “picture 20” are described after the description of the “playback log”.

Note that the editable item may be determined so as to synchronize with signage data 302 displayed on signage display device 103. Specifically, the difference between the playback time (T1) included in the playback log and the current time (T2) is calculated (T3), the signage data displayed at the time obtained by adding the difference (T3) to the playback time (T1) is specified, and the editable item is determined. For example, when the current time at which the playback log of FIG. 8C is received is “12:00:03”, T3 is three seconds since the playback time of the playback log of FIG. 8C is “12:00:00”. DS 202 is played at the time of “12:00:03”, and hence the editable item with respect to the display of DS 202 is the editable item of FIG. 9C.

The current time may be determined from the clock function held by signage server 102, or may be acquired from the NTP (Network time protocol) server, for example.

(S703) Item transmitting unit 603 transmits the editable item determined in analyzing unit 602 to signage data input device 101.

(S704) Analyzing unit 602 determines the editable item from the “content name”, the “screen name definition”, and the “constituent definition” included in the update log, and corresponding signage data 302 stored in signage data DB 607, and assumes the same as the update-content information. For example, when the update log is the case of FIG. 8G, “text 12” is the editable item compared with signage data 302.

FIG. 9F is a view showing a format of the update-content information, and FIG. 9G is a view showing the update-content information with respect to the display of DS 203A defined with the format of FIG. 9F. The format of the update-content information of FIG. 9F is defined by the description “update log”, which indicates that the update log is received and the editable item is determined, and the “content name”, the “screen name”, the “editing area name”, and the “update time” indicating the editable items. A plurality of descriptions can be made in the “editing area name”. Each of the “content name”, the “screen name”, and the “editing area name” corresponds to the “content name”, the “screen name definition”, and the “constituent definition” of signage data format 301, and the “update time” corresponds to the “update time” of the format of the update log. The update-content information of FIG. 9G is the update-content information with respect to the display of DS 203A, and “Manpuku Diner”, “Pork Cutlet Set Meal”, “text 12”, and “12:00:08” are described after the description of “update log”.

(S705) Analyzing unit 602 transmits the update-content information to item transmitting unit 603. Item transmitting unit 603 transmits the update-content information to signage data input device 101.

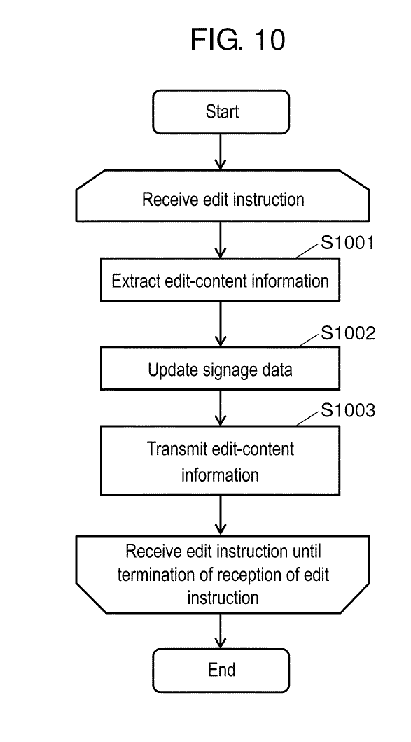

FIG. 10 is a flowchart showing the operation of the edit instruction of signage server 102. Edit instruction receiving unit 604 receives the edit instruction from signage data input device 101, and transmits the same to updating unit 605. The operation described in FIG. 10 is continued during receipt of the edit instruction transmitted from signage data input device 101.

(S1001) Updating unit 605 receives the edit instruction and extracts the content information to be edited.

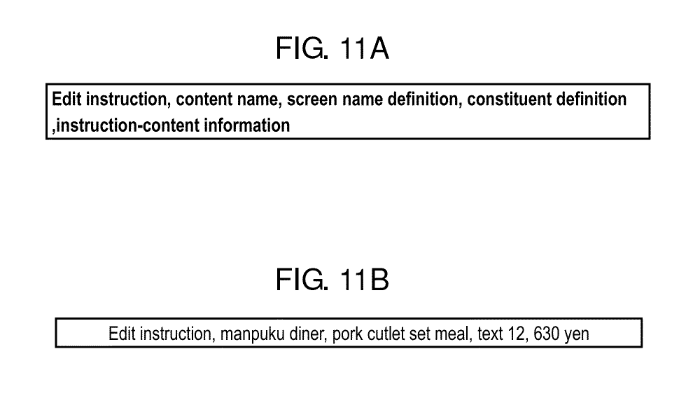

FIG. 11A is a view showing a format of the edit instruction, and FIG. 11B is a view showing the edit instruction corresponding to the edit screen of ED 203A defined with the format of FIG. 11A. The format of the edit instruction of FIG. 11A is defined by the description “edit instruction” indicating that it is the edit instruction, and the “content name”, the “screen name definition”, the “constituent definition”, and the “instruction-content information”, which are the target of edit instruction. A plurality of descriptions can be made in the “constituent definition” and the “instruction-content information”. Each of the “content name”, the “screen name definition”, and the “constituent definition” corresponds to the “content name”, the “screen name definition”, and the “constituent definition” of signage data format 301. The “instruction-content information” is specific content information of the edit instruction with respect to the “constituent definition”.

FIG. 11B shows the edit instruction corresponding to the edit screen of ED 203A, and “Manpuku Diner”, “Pork Cutlet Set Meal”, “text 12”, and “630 yen” are described after the description of “edit instruction”. Here, “text 12” is edited from “735 yen” to “630 yen”.

In the edit instruction of FIG. 11B, the instruction to edit “text 12” to “630 yen” is made.

(S1002) Updating unit 605 edits and updates the content information of the edit instruction with respect to corresponding signage data 302 of signage data DB 607, and also transmits the content information of the edit instruction to data transmitting unit 606.

(S1003) Data transmitting unit 606 sends the edit instruction to signage display device 103.

### [1-4. Configuration of Signage Data Input Device]

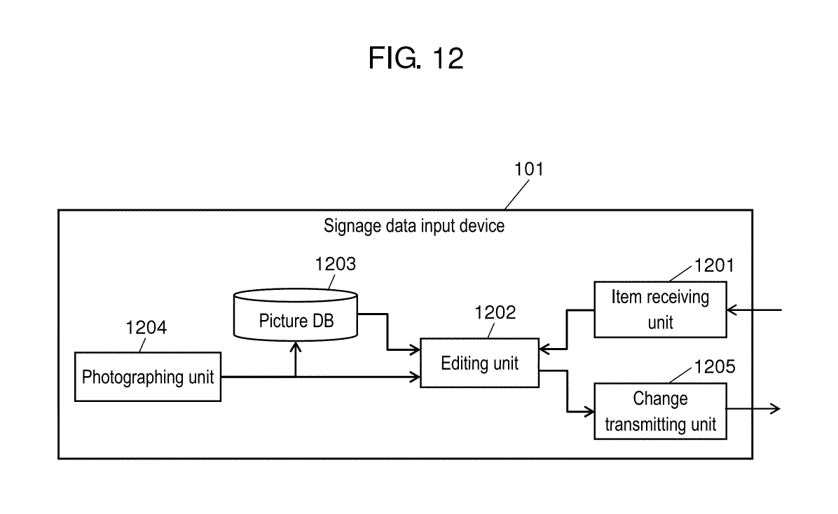

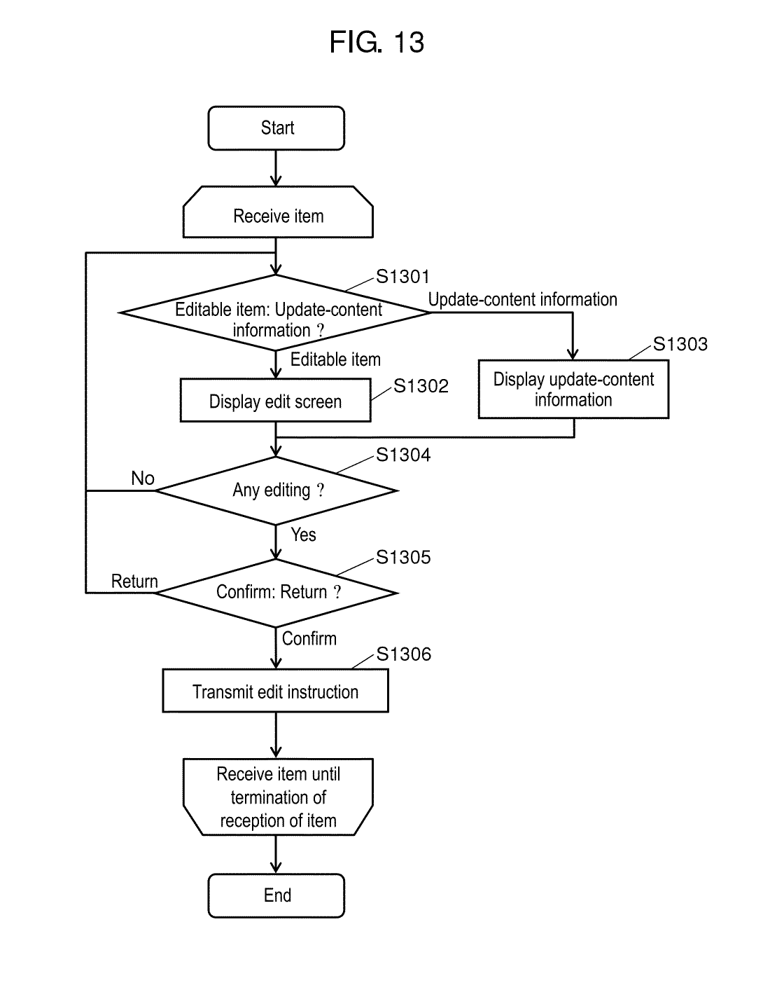

FIG. 12 is a function block diagram of signage data input device 101. FIG. 13 is a flowchart showing the operation of signage data input device 101.

Signage data input device 101 is configured by item receiving unit 1201, editing unit 1202, picture DB 1203, photographing unit 1204, and change transmitting unit 1205.

Item receiving unit 1201, editing unit 1202, and change transmitting unit 1205 are realized, for example, by a wireless or wired communication device, and a processor that executes a predetermined process. Such functions may be realized by one processor, or may be assigned and realized by a plurality of processors. Picture DB 1203 is realized, for example, by an optically-readable or magnetically-readable recording medium. Photographing unit 1204 is, for example, realized by an imaging device including an optical system such as a focus lens, and an image sensor.

Item receiving unit 1201 receives the editable item or the update-content information transmitted from signage server 102, and transmits the same to editing unit 1202. The operation described in FIG. 13 is continued while the editable item or the update-content information transmitted from signage server 102 is received.

(S1301) Editing unit 1202 determines whether the data received from item receiving unit 1201 is the editable item or the update-content information. The process proceeds to S1302 when the editable item is received, and proceeds to S1303 when the update-content information is received.

(S1302) Editing unit 1202 displays the edit screen with respect to the editable item. For example, when the editable item is the case of FIG. 9D, the edit screen displays ED 203. ED 203 is an edit screen for editing price 213 of “735 yen”, and includes a region for inputting text and an “edit” button for starting the editing. When the editable item is the case of FIG. 9B, the edit screen displays ED 201. ED 201 is provided for editing the picture, and includes an “edit” button for starting the editing, a “select” button for using the picture data accumulated in picture DB 1203, and a “camera” button for using the picture data photographed by photographing unit 1204.

(S1303) Editing unit 1202 displays the edit screen with respect to the update-content information. For example, when the update-content information is the case of FIG. 9G, the edit screen displays ED 503. ED 503 is an edit screen that shows that price 213 of “735 yen” is edited and updated to price 213A of “630 yen”, and further enables editing of price 213A of “630 yen”, and includes a region for inputting text and an “edit” button for starting editing.

(S1304) Editing unit 1202 determines whether or not the user pressed the “edit” button while an arbitrary edit screen is being displayed. When the “edit” button is pressed (if Yes), the process proceeds to S1305, and when the “edit” button is not pressed (if No), the process returns to S1301.

(S1305) When the editable item is text, the user edits the text of the region for inputting the text when editing. When the editable item is a picture, the user presses the “picture” button and selects the picture data to use from the picture data recorded in picture DB 1203 when the picture data recorded in picture DB 1203 is used for editing. When the picture data photographed by using the camera function is used for editing, the user presses the “camera” button. Photographing unit 1204 has a camera function, and may record the photographed picture data in picture DB 1203. The user presses the “confirm” button of the edit screen when the editing is terminated, and presses the “return” button of the edit screen to cancel the editing. As an example of editing, for example, the display screen is switched to ED 203A when the “edit” button of ED 203 is pressed. The user edits the text in the region for inputting the text of ED 203A, and presses the “confirm” button to confirm editing and presses the “return” button to cancel editing. In ED 203A, “735 yen” is edited to “630 yen”.

Editing unit 1202 determines whether or not the “confirm” button or the “return” button of the edit screen is pressed. When it is determined that the “confirm” button is pressed, the process proceeds to S1306, and when it is determined that the “return” button is pressed, the process returns to S1301.

(S1306) Editing unit 1202 transmits the edit-content information to change transmitting unit 1205. Change transmitting unit 1205 transmits the edit-content information received from editing unit 1202 to signage server 102. The edit instruction of FIG. 11B is transmitted to signage server 102 with respect to the edit-content information of the edit screen of ED 203A.

### [1-5. Configuration of Signage Display Device]

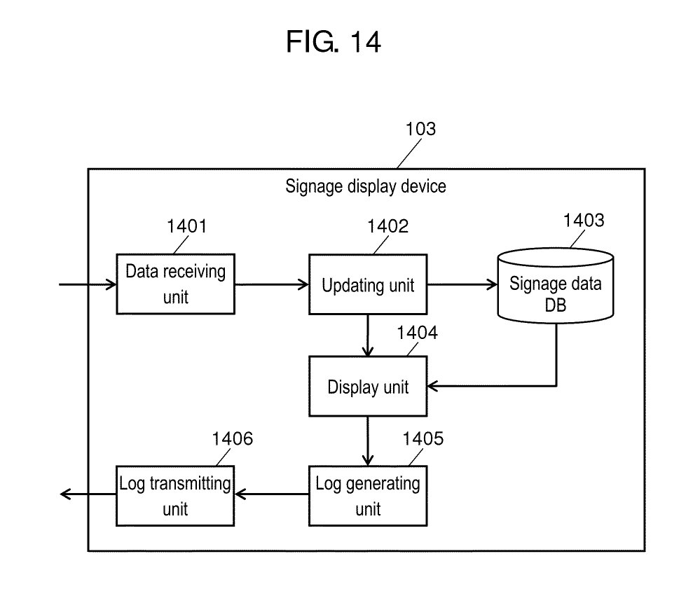

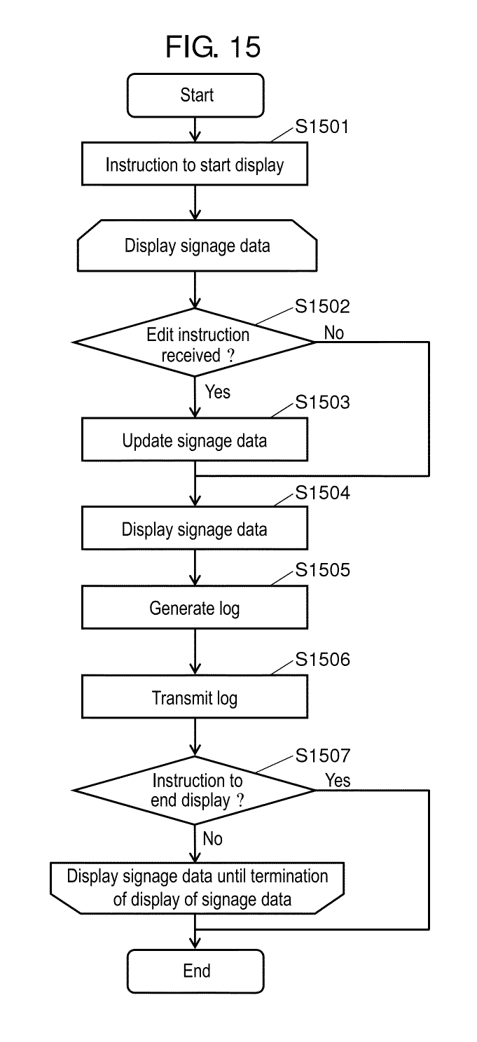

FIG. 14 is a function block diagram of signage display device 103. FIG. 15 is a flowchart showing the operation of signage display device 103.

Signage display device 103 is configured by data receiving unit 1401, updating unit 1402, signage data DB 1403, display unit 1404, log generating unit 1405, and log transmitting unit 1406.

Data receiving unit 1401 and log transmitting unit 1406 are realized, for example, by a wireless or wired communication device and a processor that executes a predetermined process. Updating unit 1402 and log generating unit 1405 are realized by a processor that executes a predetermined process. Display unit 1404 is, for example, realized by a display device such as a liquid crystal display and a processor that executes a predetermined process. Such functions may be realized by one processor, or may be assigned and realized by a plurality of processors. Signage data DB 1403 is, for example, realized by an optically-readable or magnetically-readable recording medium.

The operation described in FIG. 15 is continued until receipt of the instruction to end the display of the signage data transmitted from signage server 102.

(S1501) Data receiving unit 1401 receives the instruction to start the display of the signage data from signage server 102.

(S1502) When the edit instruction of signage data 302 is received from signage server 102, data receiving unit 1401 transmits the edit instruction to updating unit 1402 (if Yes) and proceeds to S1503. When the edit instruction is not received (if No), data receiving unit 140 proceeds to S1504.

(S1503) When the edit instruction is received, updating unit 1402 edits and updates corresponding signage data 302 recorded in signage data DB 1403.

(S1504) When signage data 302 is received at the same time as the instruction to start the display of the signage data, updating unit 1402 transmits signage data 302 to updating unit 1402, and records signage data 302 in signage data DB 1403. When signage data 302 is received separately from the instruction to start the display of the signage data, data receiving unit 1401 receives the signage data transmitted from signage server 102, transmits the same to updating unit 1402, and records signage data 302 in signage data DB 1403.

Updating unit 1402 transmits the instruction to start the display to display unit 1404. Display unit 1404 starts to display signage data 302 recorded in signage data DB 1403 when the instruction to start the display is received, and continuously displays the data if the instruction to start the display is already received. The update-content information is displayed when the edit instruction is given. As an example of the display, for example, display is made in the order of DS 201, DS 202, DS 203, DS 204, DS 205, and DS 206 as in the example of FIG. 2. As an example of the display when the edit instruction is given, for example, display is made as in DS 203A of FIG. 5.

(S1505) Log generating unit 1405 generates the playback log or the update log to transmit to signage server 102 in correspondence with the display of display unit 1404, and transmits the same to log transmitting unit 1406. The logs shown in FIG. 8C, FIG. 8D, FIG. 8E, and FIG. 8F are generated as an example of the playback log, and the log shown in FIG. 8G is generated as an example of the update log.

(S1506) Log transmitting unit 1406 transmits the playback log or the update log to signage server 102.

(S1507) When the instruction to end the display of the signage data is received from signage server 102 (if Yes), data receiving unit 1401 terminates the process, and when the instruction to end the display of the signage data is not received (if No), data receiving unit 1401 returns to S1502 and continues the process.

### [1-3. Effect]

As described above, the signage data input device of the present disclosure is a signage data input device that performs editing in conjunction with the signage data displayed on the signage display device, and includes an item receiving unit configured to receive an editable item in conjunction with the signage data displayed on the signage display device, an editing unit configured to display an edit screen for editing the editable item and accepts edit-content information, and a change transmitting unit configured to transmit the edit-content information as the edit instruction. The server of the present disclosure is a server that controls the display of the signage data of the signage display device and the editing of the signage data displayed on the signage display device of the signage data input device, and includes a log receiving unit configured to receive the display result of the signage data displayed on the signage display device as a log, an analyzing unit configured to extract the editable item from the log, an item transmitting unit configured to transmit the editable item to the signage data input device, an edit instruction receiving unit configured to receive the edit instruction with respect to the signage data displayed on the signage display device from the signage data input device, an updating unit configured to edit the signage data displayed on the signage display device based on the edit instruction, and a data transmitting unit configured to transmit the edit instruction to the signage display device.

Thus, the edit screen is displayed in conjunction with the display-content information of the signage display device, so that the display-content information can be easily changed.

In the data input device of the present disclosure, the editable item includes the update time when the signage data displayed on the signage display device is the edited signage data, and the editing unit displays the update time when the edit screen is displayed.

Thus, the change in the displayed content information of the signage display device can be known with the signage data input device.

In the data input device of the present disclosure, the editable item received by the item receiving unit includes the time displayed on the signage display device, and the editing unit calculates the difference between the current time and the time of the editable item to specify the editable item to be displayed on the edit screen.

Thus, the editable item can be determined so as to be synchronized with the signage data displayed on the signage display device.

In the server of the present disclosure, when the edit instruction receiving unit receives that editing is being carried out on the signage data displayed on the signage display device from the signage data input device, the updating unit controls the data transmitting unit so as to temporarily stop the display of the signage data being displayed on the signage display device.

Thus, the edit screen of the signage data input device and the display-content information of the signage display device become the same display-content information, and thus the editing can be carried out while viewing the display-content information of the signage display device and the display-content information of the display device can be more easily changed.

### Other Exemplary Embodiments

The data input system of the present disclosure has been described above in the exemplary embodiment. A variant of the exemplary embodiment described above will be described below.

### [2-1. Display of Update-Content Information]

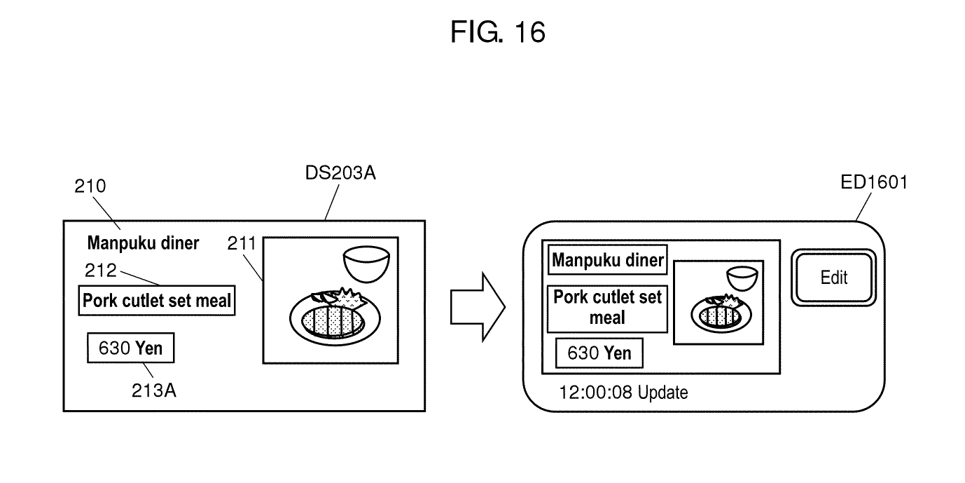

One example in which editing is performed in signage data input device 101 has been described with reference to FIG. 5, but a different display may be carried out. FIG. 16 is a view showing another example in which editing is performed by using the edit screen of signage data input device 101. As described in FIG. 5, the user presses the “edit” button of ED 203 to update price 213 of “735 yen”. When the “edit” button is pressed, the display screen is switched to ED 203A. In ED 203A, “735 yen” is edited to “630 yen”. When the “confirm” button is pressed in ED 203A, signage data input device 101 transmits the edited content information to signage server 102, and signage server 102 notifies the edited content information to signage display device 103.

Signage display device 103 that received the notification displays DS 203A, which is the update screen of DS 203. Price 213 of “735 yen” is updated to price 213A of “630 yen”. Signage display device 103 transmits the playback log indicating that update has been carried out to signage server 102, and signage sever 102 transmits the update-content information and the update time to signage data input device 101.

Signage data input device 101 displays ED 1601 of FIG. 16, which is the edit screen presenting the update-content information and the update time. ED 1601 displays DS 203A displayed on signage display device 103 as is on the screen. According to such display, the update result can be checked on signage data input device 101 without actually viewing the display result of signage display device 103. When the “edit” button is pressed in ED 1601, the updating area can be edited again.

### [2-2. Display of Edit Screen]

In the exemplary embodiment described above, the signage data is edited using signage data input device 101 in conjunction with the signage data displayed on signage display device 103, but the present disclosure is not limited thereto.

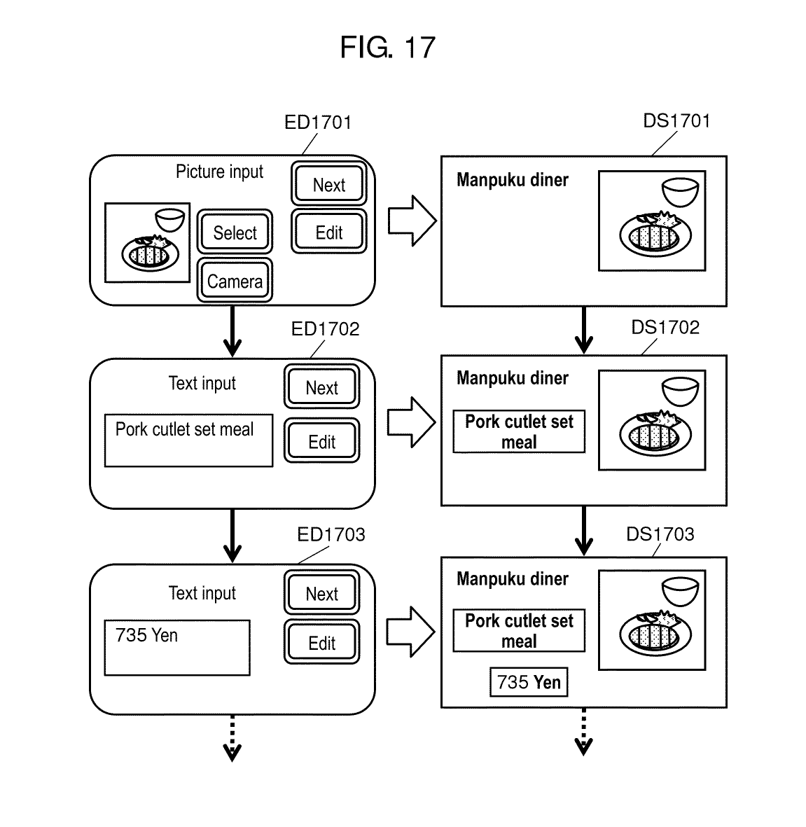

FIG. 17 is a view showing still another example in which editing is performed using the edit screen of signage data input device 101.

Signage data input device 101 does not display the edit screen in conjunction with the display of the signage data of signage display device 103, but directly decodes signage data 302 recorded in signage data DB 607 of signage server 102 and displays the same on the edit screen independently from signage display device 103. Specifically, the editable items defined in signage data 302 are switched in order from the beginning. For example, the editable items are switched in the order of ED 1701, ED 1702, ED 1703. ED 1701 is an edit screen for editing picture 211 of “Pork Cutlet Set Meal”. ED 1702 is an edit screen for editing menu name 212 of “Pork Cutlet Set Meal”. ED 1703 is an edit screen for editing price 213 of “735 yen”. ED 201, ED 202, and ED 203 described in FIG. 4 differ in that the “next” button is provided. In switching, the switching may be carried out based on the display time defined in signage data 302 or the switching may be carried out by pressing the “next” button.

The display of signage display device 103 may be switched in conjunction with the display of the edit screen of signage data input device 101. Specifically, DS 1701 is displayed while ED 1701 is being displayed on signage data input device 101, DS 1702 is displayed when the display of the edit screen is switched to ED 1702, and DS 1703 is displayed when the display of the edit screen is switched to ED 1703. In this case, the playback log is transmitted from signage data input device 101 to signage server 102, and the playback log received by signage server 102 is transmitted to signage display device 103, so that the switching of the screen can be cooperatively carried out.

### [2-3. When Plurality of Editable Items are Present]

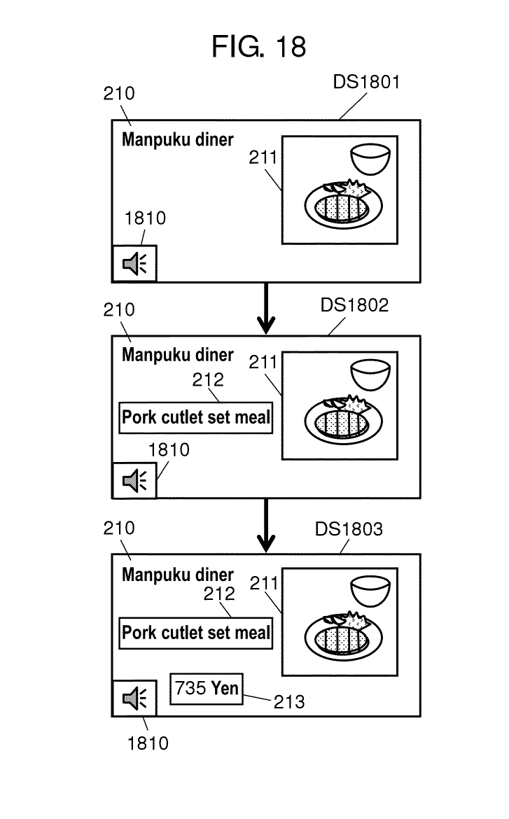

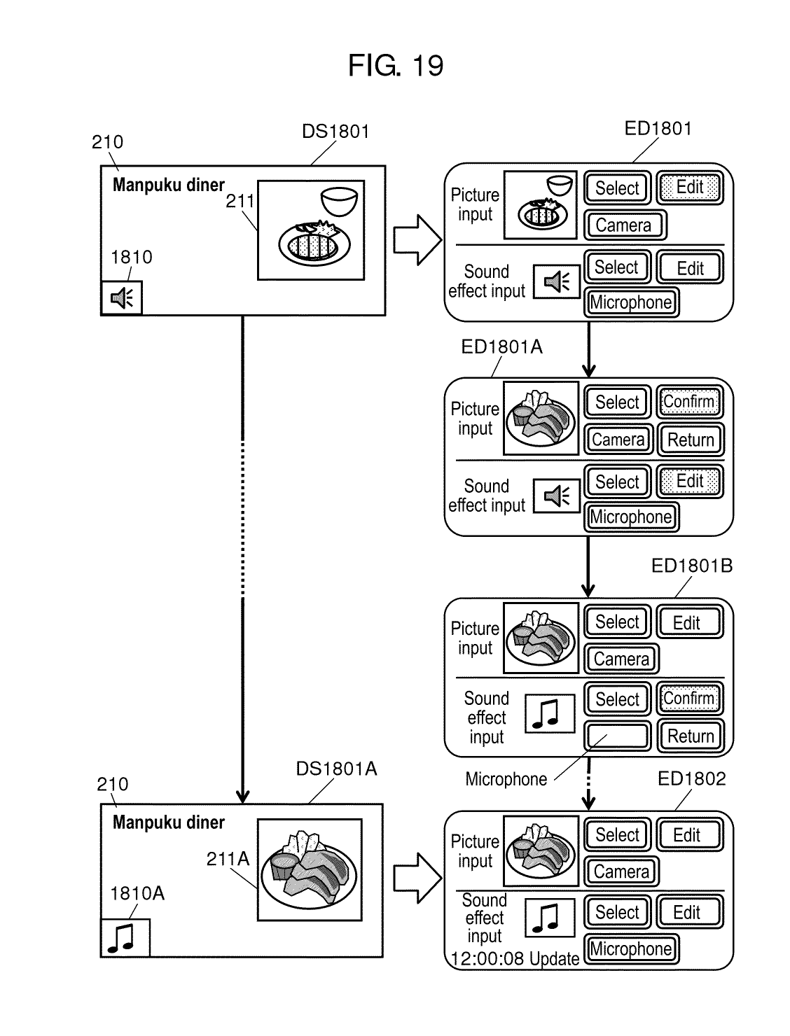

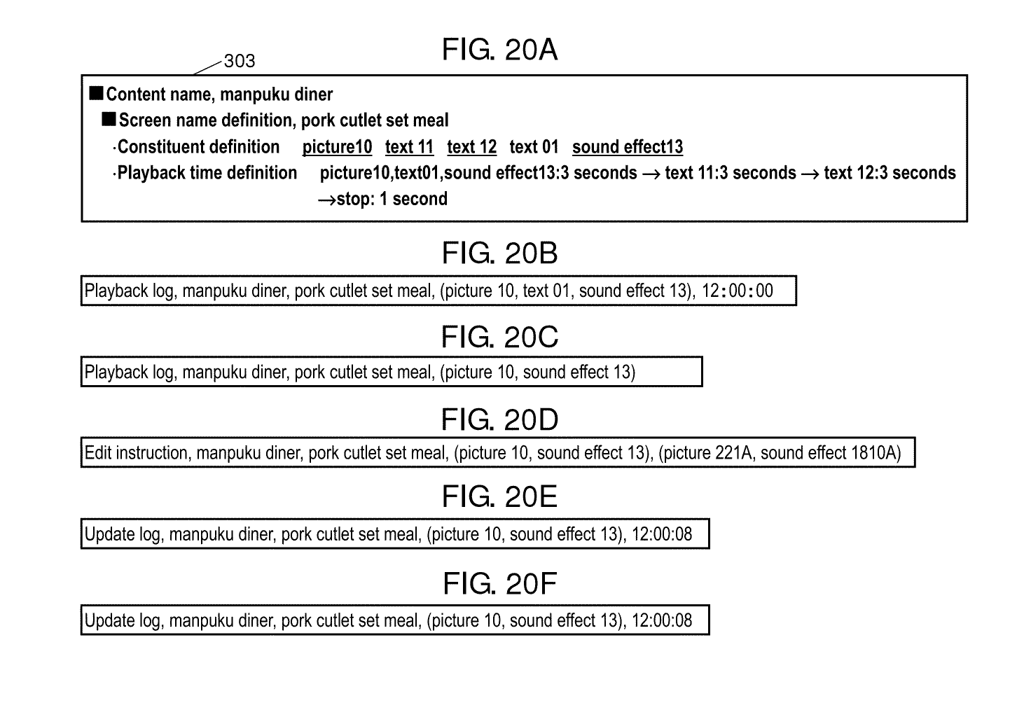

In the exemplary embodiment described above, the edit screen of signage data input device 101 has been described for editing one editable item, but the present disclosure is not limited thereto, and a plurality of editable items may be edited. Furthermore, the editable item has been described using the picture and the text, but the present disclosure is not limited thereto. FIG. 18 is a view showing another example in which signage display device 103 displays the signage data, and FIG. 19 is a view showing another example in which a plurality of editable items are present in the edit screen of signage data input device 101. FIG. 20A is a view showing another example of the signage data defined with the format of the signage data of FIG. 3A, FIG. 20B is a view showing the playback log with respect to DS 1801, to be described later, defined with the format of the playback log of FIG. 8A, FIG. 20C is a view showing the editable item with respect to the display of DS 1801, to be described later, defined with the format of FIG. 9A, FIG. 20D is a view showing the edit instruction corresponding to the edit screen of ED 1801B, to be described later, defined with the format of FIG. 11A, FIG. 20E is a view showing the update log with respect to the display of DS 1801A, to be described later, defined with the format of FIG. 8B, and FIG. 20F is a view showing the update-content information with respect to the display of DS 1801A defined with the format of FIG. 9F.

In signage data 303 of FIG. 20A, the content with the content name “Manpuku Diner” is defined. “Pork Cutlet Set Meal” is defined for the screen name. In the definition in which the screen name is “Pork Cutlet Set Meal”, “picture 10”, “text 11”, “text 12”, “text 01”, and “sound effect 13” are defined as the constituent definition, and “picture 10”, “text 11”, “text 12”, and “sound effect 13” are underlined so that the constituents are editably defined. The “picture 10” corresponds to picture 211 of “Pork Cutlet Set Meal”, “text 11” corresponds to menu name 212 of “Pork Cutlet Set Meal”, “text 12” corresponds price 213 of “735 yen”, “text 01” corresponds to restaurant name 210 of “Manpuku Diner”, and “sound effect 13” corresponds to sound effect 1810. In the definition in which the screen name is “Pork Cutlet Set Meal”, definition is made, as the playback time definition, to display “picture 10” and “text 01” for three seconds and play “sound effect 13” for three seconds. Thereafter, definition is made to add “text 11” and display for three seconds, and subsequently, add “text 12” and display for three seconds, and terminate the playback after one second. According to such definitions, the display of DS 1801, DS 1802, DS 1803 is carried out as shown in FIG. 18. The playback log of FIG. 20B is the playback log with respect to DS 1801, and “Manpuku Diner”, “Pork Cutlet Set Meal”, “(picture 10, text 1, sound effect 13)” and “12:00:00” are described after the description of “playback log”. In the playback log of FIG. 20B, “picture 10” and “sound effect 13” are editable items. The editable items of FIG. 20C are editable items with respect to the display of DS 1801, and “Manpuku Diner”, “Pork Cutlet Set Meal”, and “(picture 10, sound effect 13)” are described after the description of “playback log”.

As shown in FIG. 19, when DS 1801 is displayed on signage display device 103, the displayed content information is transmitted from signage display device 103 to signage server 102 as a playback log. Signage server 102 that received the playback log of FIG. 20B transmits picture 211 and sound effect 1810 of “Pork Cutlet Set Meal”, which are the editable items of DS 1801, to signage data input device 101. Signage data input device 101 displays ED 1801, which is the edit screen for individually editing picture 211 and sound effect 1810 of “Pork Cutlet Set Meal”. The upper part of ED 1801 is for editing of the picture, and there are provided the “edit” button for starting editing, the “select” button for using the picture accumulated in signage data input device 101, and the “camera” button for using the picture photographed by the camera provided in signage data input device 101. The lower part of ED 1801 is for editing of the sound, and there are provided the “edit” button for starting the editing, the “select” button for using the sound accumulated in signage data input device 101, and the “microphone” button for using the sound recorded with the microphone provided in signage data input device 101.

The user presses the “edit” button at the upper part of ED 1801 to update picture 211 of “Pork Cutlet Set Meal”. When the “edit” button is pressed, the display screen is switched to ED 1801A. ED 1801A is different from ED 1801 in that the “edit” button is changed to the “confirm” button and the “return” button. The editing of the picture is carried out, and the “confirm” button is pressed to confirm editing, and the “return” button is pressed to cancel editing. In ED 1801A, the picture of “Pork Cutlet Set Meal” is edited to a different picture. Next, the “edit” button at the lower part of ED 1801 is pressed to update sound effect 1810 of “Pork Cutlet Set Meal”. When the “edit” button is pressed, the display screen is switched to ED 1801B. ED 1801B is different from ED 1801A in that the “edit” button is changed to the “confirm” button and the “return” button. The editing of the sound effect is carried out, and the “confirm” button is pressed to confirm editing, and the “return” button is pressed to cancel editing. In ED 1801B, the sound effect of “Pork Cutlet Set Meal” is edited to a different sound effect.

When the “confirm” button is pressed in ED 1801B, signage data input device 101 transmits the edited content information to signage server 102, and signage server 102 notifies the edited content information to signage display device 103. The edit instruction of FIG. 20D is the edit instruction corresponding to the edit screen of ED 1801B, and “Manpuku Diner”, “Pork Cutlet Set Meal”, “(picture 10, sound effect 13)”, and “(picture 211A, sound effect 1810A)” are described after the description of “edit instruction”. Here, “(picture 10, sound effect 13)” is edited from picture 211 to picture 211A, and from sound effect 1810 to sound effect 1810A.

Signage display device 103 that received the notification displays DS 1801A, which is the update screen of DS 1801. Picture 211 of “Pork Cutlet Set Meal” is updated to picture 211A, and sound effect 1810 is updated to sound effect 1810A. Signage display device 103 transmits the update log indicating that update has been carried out to signage server 102, and signage server 102 transmits the update-content information and the update time to signage data input device 101. The update log of FIG. 20E is the update log with respect to the display of DS 1801A, and “Manpuku Diner”, “Pork Cutlet Set Meal”, “(picture 10, sound effect 13”), and “12:00:08” are described after the description of “update log”.

Signage data input device 101 displays the edit screen with respect to the update-content information. The update-content information of FIG. 20F is the update-content information with respect to the display of DS 1801A, and “Manpuku Diner”, “Pork Cutlet Set Meal”, “(picture 10, sound effect 13)”, and “12:00:08” are described after the description of “update log”. When the update-content information is the case of FIG. 20F, the edit screen displays ED 1802. ED 1802 is the edit screen for showing that picture 211 of “Pork Cutlet Set Meal” is edited and updated to picture 211A and sound effect 1810 is updated to sound effect 1810A, and for further editing picture 211A and sound effect 1810A. Even if there are a plurality of editable items, the display-content information can be easily changed in conjunction with the display-content information of the signage display device.

In the case where a plurality of editable items are present, the combination is not limited to only the picture and the sound effect, but may be a plurality of pictures, and the combination is not limited such as picture and text, text and sound effect, and the like.

In the case where a plurality of editable items are present, two items were displayed in one edit screen, but the present disclosure is not limited thereto. The editable items may be individually displayed.

In the case where a plurality of editable items are present, the edit instruction was given after the editing of all of the plurality of items is confirmed, but the present disclosure is not limited thereto. The edit instruction may be given each time the editing of one item is confirmed.

### [2-4. Supplement]

The data input system of the present disclosure has been described, but the following modifications may be made.

(1) A part of or all of the constituents of signage server 102 may be provided in signage data input device 101.

(2) The signage data to update is not limited to image, text, and sound effect, and for example, may be a moving image.

What is claimed is:

1. A signage data input device which performs editing in conjunction with signage data displayed on a signage display device, the signage data input device comprising:
an item receiving unit configured to receive an editable item in conjunction with the signage data displayed on the signage display device;
an editing unit configured to display an edit screen for editing the editable item and accepts edit-content information; and
a change transmitting unit configured to transmit the edit-content information as an edit instruction.

2. The signage data input device according to claim 1, wherein
the editable item includes an update time when the signage data displayed on the signage display device is edited signage data, and
the editing unit displays the update time when the edit screen is displayed.

3. The signage data input device according to claim 1, wherein
the editable item received by the item receiving unit includes a time displayed on the signage display device, and
the editing unit calculates a difference between a current time and a time of the editable item, and specifies an editable item to be displayed on the edit screen.

4. A server which controls a display of signage data of a signage display device, and editing of the signage data displayed on the signage display device of a signage data input device, the server comprising:
a log receiving unit configured to receive a display result, as a log, of the signage data in conjunction with the signage data displayed on the signage display device;
an analyzing unit configured to extract an editable item from the log;
an item transmitting unit configured to transmit the editable item to the signage data input device;
an edit instruction receiving unit configured to receive an edit instruction with respect to the signage data displayed on the signage display device from the signage data input device;
an updating unit configured to edit the signage data displayed on the signage display device based on the edit instruction; and
a data transmitting unit configured to transmit the edit instruction to the signage display device.

5. The server according to claim 4, wherein
when the edit instruction receiving unit receives from the signage data input device that the signage data displayed on the signage display device is being edited, the updating unit controls the data transmitting unit to temporarily stop the display of the signage data being displayed on the signage display device.

6. A signage data input method for performing editing in conjunction with signage data displayed on a signage display device, the signage data input method comprising:
an item receiving step of receiving an editable item in conjunction with the signage data displayed on the signage display device;
an editing step of displaying an edit screen for editing the editable item and accepting edit-content information; and
a change transmitting step of transmitting the edit-content information as an edit instruction.
